(19) United States
(12) Patent Application Publication
(10) Pub. No.: US 2008/0225767 A1
(43) Pub. Date: Sep. 18, 2008

(54) Device for Implementing a RNC Using LVDS

(75) Inventor: Kyung Hwan An, Seongnam-si (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTSTARCOM, INC., Alameda, CA (US)

(21) Appl. No.: 11/534,965

(22) Filed: Dec. 18, 2006

Related U.S. Application Data
(63) Continuation of application No. 10/559,738, now abandoned.

(30) Foreign Application Priority Data
Jul. 24, 2003 (KR) 10-2003-0051165

(51) Int. Cl. H04B 7/00

(52) U.S. Cl. 370/310.1

(57) ABSTRACT

A device for implementing a RNC is provided with an interface interfacing between sub-systems of a system for the RNC. The interface uses cross duplication dualizing interfacing method. In the device of the present invention, the data transmission between the sub-systems is performed in the form of LVDS signals converted from ATM UTOPIA data. Further, the active pass link of two interfaces is switched, while outputs are transmitted from the active pass link to two interfaces.

### TECHNICAL FIELD

The present invention generally relates to a device for implementing a RNC (Radio Network Controller) by using LVDS, and particularly to the device which facilitates the arrangement of a system and enhances the accuracy of a circuit.

### BACKGROUND ART

Conventionally, when an ATM switching infrastructure is established, optic cables are utilized as an interface between the sub-systems of the RNC system.

FIGS. 1 and 2 show the conventional interface between the sub-systems of the RNC system. FIG. 1 shows a block diagram of the RNC and FIG. 2 shows a block diagram of a part of the VAIA circuit interface in the RNC.

As shown in FIG. 1, an optic cable (STM-1 (ATM)) is used as the interface between the sub-systems of the RNC. Further, the ATM switch is required to have its switching capacity of 5 G, 32 ports since two ATM ports are assigned to each of the sub-systems for dualizing.

As shown in FIG. 2, a part of the VAIA circuit interface in the system for the RNC (shown in FIG. 1), wherein Rx and Tx sections have the same configuration.

As shown in FIG. 2, a UNI 10 is an ATM user network interface. It converges an ATM transmission and converts UTOPIA data into differential PECL. An optic module 20 outputs the optic signals converted from ATM data that are transmitted from the UNI 10.

As described above, the optic cables are used as the interface between the sub-systems of the system constituting the prior art RNC. However, the optic cables have to use expensive optic modules. Further, the ATM switch links are used in such a way that two ATM switch links are assigned for each dualizing. Therefore, although expensive ATM switch links are employed, only a half of the ATM switch links is used in the prior art.

### DISCLOSURE OF THE INVENTION

### Technical Solution

Thus, it is an object of the present invention to provide a device for implementing a RNC by using LVDS, wherein an easy arrangement of a system for the RNC and an enhanced accuracy of a circuit are obtained by implementing a new LVDS interface from the established form. This is achieved by adding a rear board to an existing circuit in the form of an optic interface with a modification of the existing circuit, and further by implementing a system through using the LVDS interface as an interface between the sub-systems.

In order to achieve the above object, the present invention provides a device for implementing a RNC which comprises an interface interfacing between sub-systems of a system for the RNC. The interface uses cross duplication dualizing interfacing method, wherein the data transmission between the sub-systems is performed in the form of LVDS signals converted from ATM UTOPIA data. The active pass link of two interfaces is switched while the outputs are transmitted from the active pass link to the two interfaces.

In accordance with one aspect of the present invention, the device further comprises a Tx circuit section. Such section comprises a buffer for outputting the UTOPIA data being inputted and a LVDS driver section for receiving the input UTOPIA data in a parallel form from the buffer 100. This is for converting the parallel UTOPIA data into LVDS data via two LVDS drivers for data dualizing and for transmitting the converted data to an ATM switch.

In accordance with another aspect of the present invention, the device further comprises an Rx circuit section. Such section comprises a LVDS receiver section for converting LVDS data transmitted from an ATM switch into the ATM UTOPIA data and for outputting the ATM UTOPIA data after selecting one of two data through two LVDS receivers. It further comprises a switch selecting active data from the data in dualized form being inputted from a LVIA.

### BRIEF DESCRIPTION OF THE DRAWINGS

FIG. 1 is a block diagram showing the scheme of a prior art RNC.

FIG. 2 is a block diagram showing a part of an interface of a VAIA circuit used in a system for the prior art RNC.

FIG. 3 is a block diagram showing an interface of a RNC system implemented with an LVDS of the present invention that is applied between sub-systems.

FIG. 4 is a block diagram showing a Tx section of the system for an RNC of the present invention provided with LVIA boards.

FIG. 5 is a block diagram showing an Rx section of the system for an RNC of the present invention provided with LVIA boards.

### BEST MODE FOR CARRYING OUT THE INVENTION

A preferred embodiment of the inventive device for implementing a RNC using a LVDS in accordance with the technical thoughts depicted above will be described in detail with reference to the accompanying drawings.

A LVDS interface, which is applied in the present invention, is a circuit that may be formed by a commercial interface chip capable of performing a high-rate data transmission. Further, the LVDS interface may provide a powerful system interface by properly selecting a transmission dock and devices. Moreover, such interface is applicable to all kinds of communications.

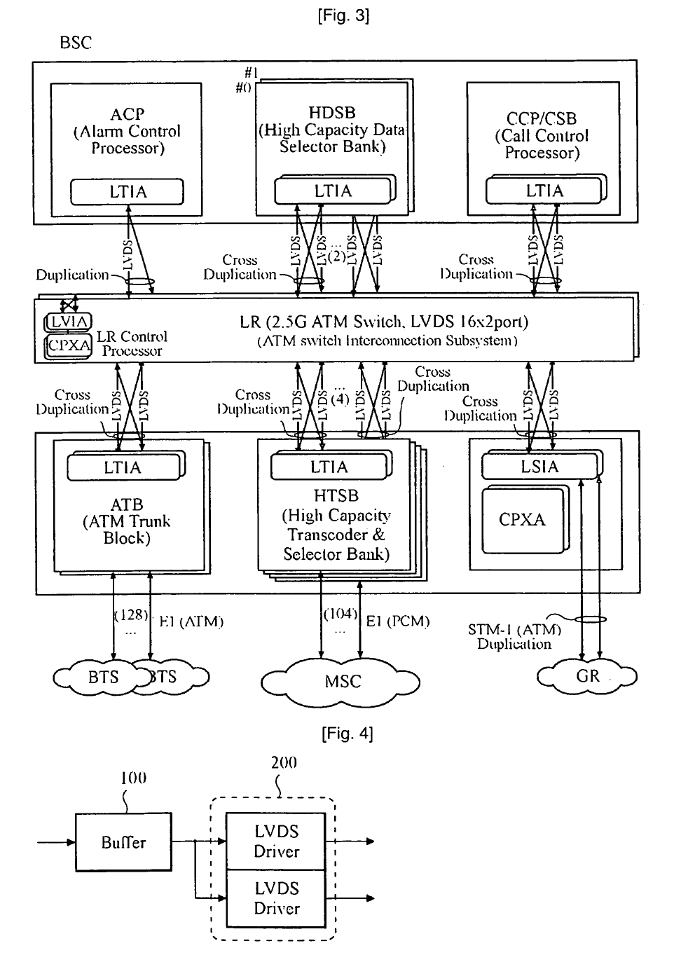

FIG. 3 is a block diagram showing an interface of a system for an RNC implemented with the inventive LVDS that is applied between sub-systems. In the system, the VAIA rear card is replaced with a LVIA rear card that is newly developed in the present invention. The LVDS interface is used for the system interface instead of being utilized as the optic cables.

As shown therein, the data transmission between the sub-systems is achieved via the LVDS interface that uses a cross duplication dualizing interfacing method in the system of the present invention.

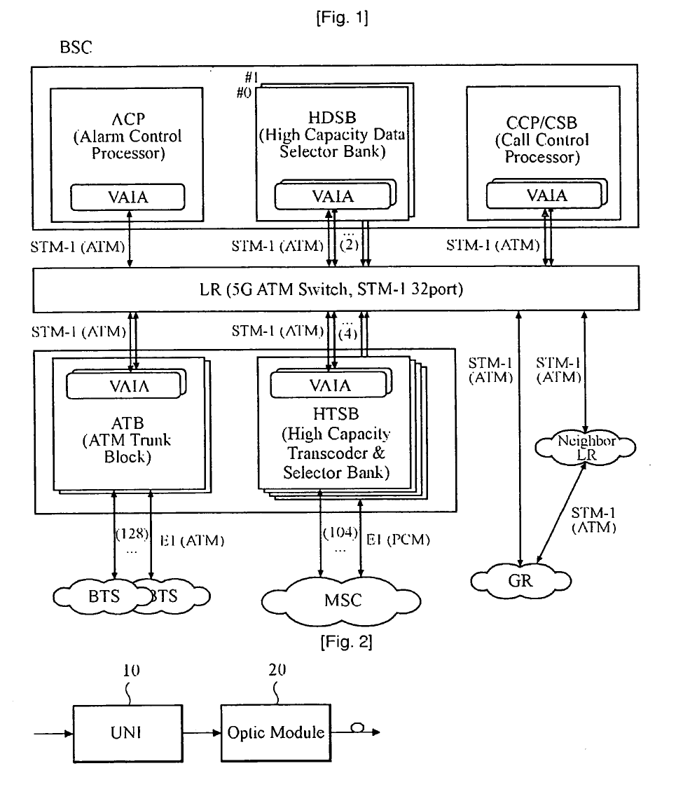

In the system of the present invention, only an active pass link of two interfaces is switched, while the output is transmitted from the active pass link to two interfaces. Accordingly, the required capacity for an ATM switch is only of 2.5 G and 16 ports, which is smaller than that of the ATM switch shown in FIG. 1. In other words, since an ATM switch having a relatively smaller capacity can be used, the system of the present invention has a relatively increased efficiency.

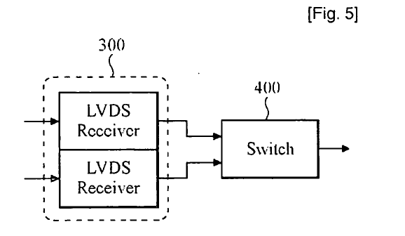

FIG. 4 is a block diagram showing a Tx section of the system for the RNC provided with LVIA boards. FIG. 5 is a block diagram showing an Rx section of the system for the RNC of the present invention provided with LVIA boards.

Circuits of the Tx and Rx sections form a pair for both the LVIA board and the ATM switch board. The configurations of the Tx and Rx sections are as follows.

As shown in FIG. 4, reference numeral 100 represents a buffer for transmitting the input UTOPIA data to a LVDS driver section 200. Reference numeral 200 designates the LVDS driver section for converting the parallel UTOPIA data from the buffer 100 into LVDS data via two LVDS drivers for data dualizing and for transmitting the converted data to the ATM switch.

As shown in FIG. 5, reference numeral 300 represents a LVDS receiver section for converting the LVDS data transmitted from the ATM switch into the ATM UTOPIA data and for transmitting the UTOPIA data to a switch 400 after selecting one of two data through LVDS receivers. Reference numeral 400 represents the switch functioning to select active data from dualized data being inputted from the LVIA.

The device of the present invention is for implementing the RNC by using LVDS. The device facilitates the arrangement of a system and enhances the accuracy of a circuit. This is achieved by implementing a LVDS interface in the new form from the established form via an addition of a rear board to an existing circuit in the form of an optic interface with a modification of the existing circuit, and also by implementing a system using the LVDS interface as an interface between the sub-systems.

### INDUSTRIAL APPLICABILITY

The device of the present invention reduces time and cost which result from the redesigning process. Further, a simple circuit and an accurate dualizing may be achieved by applying the circuit implemented with the LVDS interface to a LVIA rear board without redesigning a front board of the RNC that is used in the existing system.

In the present invention, since the data transmission is performed by converting the ATM UTOPIA data to the LVDS data, general cables can be used instead of the optic cables. Further, the use of the LVDS reduces costs and enables the ATM switch to be configured in an efficient manner.

While the present invention has been shown and described with respect to particular embodiments, it will be apparent to those skilled in the art that many changes and modifications may be made without departing from the spirit and scope of the invention as defined in the appended claims. Therefore, the scope of the present invention is not limited to the embodiment described above and it should be determined under the consideration of the appended claims and the equivalents thereof.

1. A device for implementing a RNC, comprising:
an interface interfacing between sub-systems of a system for the RNC, the interface using cross duplication dualizing interfacing method;
wherein a data transmission between the sub-systems is performed in a form of LVDS signals converted from ATM UTOPIA data and an active pass link of two interfaces is switched, while outputs are transmitted from the active pass link to two interfaces.

2. The device of claim 1, further comprising:
a Tx circuit section comprising:
a buffer for outputting the UTOPIA data being inputted; and
a LVDS driver section for receiving the input UTOPIA data in a parallel form from the buffer 100 for converting the parallel UTOPIA data into LVDS data via two LVDS drivers for data dualizing and for transmitting the converted data to an ATM switch.

3. The device of claim 1, further comprising:
an Rx circuit section comprising:
a LVDS receiver section for converting LVDS data transmitted from an ATM switch into the ATM UTOPIA data and for outputting the ATM UTOPIA data after selecting one of two data through two LVDS receivers; and
a switch selecting active data from data in dualized form being inputted from a LVIA.
